(19) United States
(12) Patent Application Publication
(10) Pub. No.: US 2021/0352949 A1
(43) Pub. Date: Nov. 18, 2021

(54) LOW SUGAR FLOUR MIX

(71) Applicant: NISSHIN FOODS INC., Tokyo (JP)

(72) Inventors: Mie KANEMARU, Tokyo (JP); Masato FUKUDA, Tokyo (JP)

(73) Assignee: NISSHIN FOODS INC., Tokyo (JP)

(21) Appl. No.: 17/286,940

(22) PCT Filed: Dec. 19, 2019
(86) PCT No.: PCT/JP2019/049736

§ 371 Date: Apr. 20, 2021

(30) Foreign Application Priority Data
Dec. 19, 2018 (JP) 2018-237088

(51) Int. Cl. A23L 33/22; A21D 2/18; A21D 2/26; A21D 2/16; A21D 10/00; A23L 7/157; A23L 23/00; A23L 29/212; A23L 13/50; A21D 13/44

(52) U.S. Cl. CPC A23L 33/22; A21D 2/186; A21D 2/265; A21D 2/16; A21D 10/005; A23V 2002/00; A23L 23/00; A23L 29/212; A23L 13/57; A21D 13/44; A23L 7/157

(57) ABSTRACT

Provided is a low-carbohydrate wheat flour mix containing 25 mass % or greater of a dietary fiber material, 3 to 30 mass % of gluten, 1 to 20 mass % of starch derived from an underground plant part, and 60 mass % or less of wheat flour, all with respect to the total mass of the mix. Preferably, the low-carbohydrate wheat flour mix further contains 0.1 to 1 mass % of an emulsifier. The low-carbohydrate wheat flour mix contains dietary fiber, which leads low-carbohydrate and low-calorie, and can be used in the production of bakery food products, deep-fried food products, and sauces in the same manner as for ordinary wheat flour.

### TECHNICAL FIELD

The present invention relates to a low-carbohydrate wheat flour mix that can be used in the production of bakery food products such as cakes and okonomiyaki (Japanese savory pancakes), deep-fried food products such as tempura and karaage (Japanese deep-fried chicken), and sauces such as white sauces, and more particularly relates to a low-carbohydrate wheat flour mix that contains dietary fiber, which leads to low-carbohydrate and low-calorie, and can be used in the production of bakery food products, deep-fried food products, and sauces in the same manner as for ordinary wheat flour.

### BACKGROUND ART

Wheat is a grain that is processed into staple foods such as bread and noodles and is eaten worldwide. Rice is a similar grain, but wheat and rice are greatly different from each other in the following fact: rice is usually eaten with the shape of its seeds still kept, whereas wheat is eaten in the form of various wheat flour food products, such as bread and noodles, as well as coatings of deep-fried food products, sauces, and others, which are obtained by first grounding seeds of what to prepare wheat flour and then processing the wheat flour. The properties of wheat flour vary depending on the type of wheat, which is the raw material, and wheat flours suited for various uses are on the market, including wheat flours for bread, wheat flours for cakes, and wheat flours for noodles. Moreover, mixed wheat flours composed of different types of wheat flours, and mixes including wheat flours and auxiliary materials such as starch have also been developed for various food products, and coating mixes for deep-fried food products such as tempura and karaage (Japanese deep-fried chicken), okonomiyaki mixes, and other mixes are also commercially available.

Recently, health management methods that restrict the intake of carbohydrates have been attracting attention. Carbohydrates are one of the three major nutrients, the others being lipids and proteins. After being absorbed into the body, carbohydrates are partly converted to lipids and accumulate, thereby contributing to an increase in body fat. Also, when a large amount of carbohydrates is ingested to allow the blood sugar level to rise, this may pose a risk factor of diabetes. Although wheat flour is indispensable to the modern diet, it contains about 80% of starch, which is a carbohydrate, and there are cases where it is necessary to restrict the use of wheat flour. Moreover, recently, as health consciousness has been increasing, the trend toward actively adopting carbohydrate restriction in everyday diets is accelerating, and a large number of therapies, diet methods, and the like that restrict carbohydrates have been advocated. Under such circumstances, there is an increasing need for a wheat flour food product that includes a reduced amount of carbohydrate and is suitable for carbohydrate restriction.

A known wheat flour food product that is advertised as a low-carbohydrate food is obtained by replacing carbohydrates in an ordinary wheat flour food product with dietary fiber, which is unlikely to be digested by human digestive enzymes. Resistant starch, resistant dextrin, inulin, and the like are used as the dietary fiber here. When a wheat flour food product contains dietary fiber, the amount of carbohydrates in the wheat flour food product is reduced, but the original texture, taste, flavor, and the like of the wheat flour food product are degraded to impair the deliciousness of the food, which is drawback. Various proposals have been made to address this problem.

For example, Patent Literature 1 discloses a wheat flour food product containing a dietary fiber-enriched composition in an amount of 6 to 45 wt %, the dietary fiber-enriched composition being composed of 7 to 50 wt % of low viscous soluble dietary fiber, such as resistant dextrin, and 50 to 93 wt % of modified starch having a hydroxypropyl group. Patent Literature 2 discloses the addition of a raw material powder containing an edible powder containing mainly inulin and a wheat bran powder to the ingredients of bread, cakes, udon noodles, and others. Patent Literature 3 discloses a diet food which comprises a soluble dietary fiber powder mainly containing inulin and an insoluble dietary fiber selected from the group consisting of wheat bran, rice bran, and soybean fiber, wherein the weight ratio of the insoluble dietary fiber to the soluble dietary fiber is 2-20.

Furthermore, Patent Literature 4 discloses a snack containing component (i): grain flour and/or starch, component (ii): resistant starch, and component (iii): resistant dextrin, and/or inulin having an average molecular weight of 1,000 or greater, wherein the ratio of component (ii) to component (iii) is within a specific range.

However, wheat flour food products obtained by using these technologies are tough, mealy, and dry and crumbly, and therefore have a poor texture.

Patent Literature 5 discloses a food composition for a batter, the composition containing a low-carbohydrate food material and koji. Patent Literature 5 discloses a list of examples of the low-carbohydrate food material including resistant starch, resistant dextrin, soybean flour, soybean milk powder, soy pulp, wheat bran, cellulose, polydextrose, wheat dietary fiber, soybean dietary fiber, resistant glucan, agar, konjac powder, almond powder, nuts powder, wheat protein, soybean protein, pea protein, and egg protein. The food composition disclosed in Patent Literature 5 contains koji, and thus has the advantages, for example, of improving meltability in the mouth and providing the effect of masking a fibrous feel (fibrous texture); however, the composition is difficult to use in the case where the flavor of koji is not favored.

### CITATION LIST

### Patent Literature

Patent Literature 1: JP H10-243777A

Patent Literature 2: JP 2008-79606A

Patent Literature 3: US 2009/202674A

Patent Literature 4: JP 2017-57484T

Patent Literature 5: JP 2017-55662A

### SUMMARY OF INVENTION

An object of the present invention is to provide a low-carbohydrate wheat flour mix that contains dietary fiber, which leads to low-carbohydrate and low-calorie, and can be used in the production of bakery food products, deep-fried food products, and sauces in the same manner as for ordinary wheat flour.

The present invention provides a low-carbohydrate wheat flour mix containing 25 mass % or greater of a dietary fiber material, 3 to 30 mass % of gluten, 1 to 20 mass % of starch derived from an underground plant part, and 60 mass % or less of wheat flour, all with respect to the total mass of the mix.

Also, the present invention provides a method for producing a bakery food product, a deep-fried food product, or a sauce, the method including using the above-described low-carbohydrate wheat flour mix.

### DESCRIPTION OF EMBODIMENTS

A low-carbohydrate wheat flour mix of the present invention contains 25 mass % or greater of a dietary fiber material, 3 to 30 mass % of gluten, 1 to 20 mass % of starch derived from an underground plant part (hereinafter also referred to as “underground starch”), and 60 mass % or less of wheat flour.

The dietary fiber material used in the present invention is a food material containing mainly dietary fiber. Dietary fiber refers to food components that are not digested by human digestive enzymes, and is classified into two groups: those functioning as structural components of plants, such as cellulose and lignin; and the others, such as gums and modified starches. Also, dietary fiber can be classified into soluble dietary fibers and insoluble dietary fibers, according to the solubility in water. Examples of soluble dietary fibers include inulin, pectin, agar, alginic acid, gum arabic, guar gum, polydextrose, and resistant dextrin. Examples of insoluble dietary fibers include cellulose, hemicellulose, lignin, chitin, chitosan, resistant starch, soybean dietary fiber, beet fiber, wheat bran, pea fiber, apple dietary fiber, citrus fiber, wheat fiber, oat fiber, sugarcane fiber, and potato fiber.

There are cases where a dietary fiber material contains, in addition to dietary fiber, other components such as a digestible component. The dietary fiber materials containing other components can also be used as the dietary fiber material in the present invention. In order to ensure that a low-carbohydrate, low-calorie wheat flour food product is obtained even more reliably, the dietary fiber material used in the present invention has a “dietary fiber content” of preferably 60 mass % or greater, more preferably 70 mass % or greater, and even more preferably 80 mass % or greater. The “dietary fiber content” means a value that is quantitatively determined using an enzyme-weight method (Prosky method) based on AOAC985.29. The “dietary fiber content” can be measured using a commercially available measurement kit based on the Prosky method, such as a Dietary Fiber Assay Kit (Wako Pure Chemical industries, Ltd.).

The dietary fiber material used in the present invention may contain a single kind of the above-described dietary fibers or a combination of two or more of them. Preferably, the dietary fiber material used in the present invention contains a soluble dietary fiber and an insoluble dietary fiber (specifically, it is preferable to use, as the dietary fiber material, a soluble dietary fiber-containing material and an insoluble dietary fiber-containing material in combination). If only a soluble dietary fiber is used, a wheat flour food product made from the low-carbohydrate wheat flour mix may have a soggy texture, and if only an insoluble dietary fiber is used, the wheat flour food product may have a rough texture. In the present invention, the mass ratio between the soluble dietary fiber and the insoluble dietary fiber (soluble dietary fiber: insoluble dietary fiber) is preferably 10:1 to 1:10, and particularly preferably 2:1 to 1:2.

It is preferable to use inulin as the soluble dietary fiber. Inulin is a substance in which about 1 to 60 fructose molecules are linked to the fructose residue of sucrose via a β(2,1) bond, and inulin functions as a storage polysaccharide in plants. Inulin is found abundantly in underground parts of chicory and Jerusalem artichoke and also in many grains and vegetables, and can be extracted from these plants for use. Also, a method for producing inulin by microorganisms has recently been found, and such inulin yielded by microorganisms can also be used. A commercially available product of inulin can also be used as the soluble dietary fiber-containing material, and specific examples thereof include Fuji FF (manufactured by Fuji Nihon Seito Corporation) and Raftiline (manufactured by Orafti).

It is preferable to use resistant starch as the insoluble dietary fiber. Starch is a polymer composed of numerous glucose molecules linked via α(1,4) and α(1,6) bonds, and starches of biological origin are typically broken down by digestive enzymes. However, starches that have a specific structure in part or the entirety thereof and chemically modified starches are resistant to digestive enzymes, even though they are of biological origin.

Resistant starch is classified into the following four types, RS1 to RS4.

RS1 is starch that is physically protected by an outer skin or the like and thus is not affected by digestive enzymes to thereby show resistance to digestion, though the starch itself is easily digestible. RS1 is found mainly in whole grain flour, seeds, legumes, and the like.

RS2 is starch (raw starch) that is resistant to digestion because of its special crystal structure of starch granules, and examples thereof include potato starch that has undergone wet-heat treatment under low moisture conditions, and unripe banana starch. High-amylose starch, which has a high content of amylose having a straight chain structure, is also classified into RS2. As used herein, the term “high-amylose starch” refers to starch with an amylose content of 50 mass % or greater.

RS3 is starch that is resistant to digestion because of its changed structure through retrogradation of the starch, the changed structure being unlikely to be affected by digestive enzymes, and an example thereof is retrograded starch (β′-starch), which is obtained by once gelatinizing (pregelatinizing) starch through heating and then cooling the gelatinized (pregelatinized) starch.

RS4 is starch that has been highly chemically modified to be resistant to digestion, and examples thereof include highly cross-linked starch and etherified and/or esterified starch.

In the present invention, any of RS1 to RS4 can be used. Particularly, an insoluble dietary fiber-containing material containing resistant starch that is classified into RS2 or RS4 and having a “dietary fiber content” of 60 mass % or greater is preferably used.

The resistant starch may be naturally occurring starch (unmodified starch) or may be modified starch. However, in general, most of the dietary fiber materials that contain naturally occurring resistant starch have a “dietary fiber content” of less than 30 mass % at most, and are often unsuitable for use in the present invention. In contrast, for example, a dietary fiber material that contains RS2 and has been undergone heat treatment, such as wet-heat treatment, has an increased “dietary fiber content” due to the heat treatment, and is preferable for use in the present invention. Specifically, for example, in the case of high-amylose corn starch with an amylose content in starch of 70 mass %, its “dietary fiber content” is only about 20 mass % in its unmodified state before heat treatment, but is approximately 60 mass % after wet-heat treatment.

A product that is commercially available as resistant starch can also be used as the insoluble dietary fiber-containing material. Examples of a product containing RS2 include Nisshoku Roadster (manufactured by Nihon Shokuhin Kako Co., Ltd.), Hi-Maize 1043 (manufactured by Ingredion Japan K.K.), and Actistar 11700 (manufactured by Cargill Japan). Examples of a product containing RS4 include Pine Starch RT (manufactured by Matsutani Chemical Industry Co., Ltd.), Fiber Gym RW (manufactured by Matsutani Chemical Industry Co., Ltd.), and Actistar RT 75330 (manufactured by Cargill Japan).

The amount of the dietary fiber material contained in the low-carbohydrate wheat flour mix of the present invention is 25 mass % or greater, preferably 30 to 60 mass %, and more preferably 34 to 50 mass %, with respect to the total mass (dry mass, the same applies hereinafter) of the mix. If the amount of dietary fiber contained in the low-carbohydrate wheat flour mix is less than 25 mass %, the reduction in carbohydrates and calories in a wheat flour food product to be obtained is insufficient due to a shortage of dietary fiber, and expected health functions may not be obtained. On the other hand, if the amount of dietary fiber contained in the low-carbohydrate wheat flour mix is high, and especially exceeds 60 mass %, the wheat flour food product may have a mealy, and dry and crumbly texture.

The gluten used in the present invention is a protein mixture of gliadin and glutenin, which are proteins contained in wheat. When a dough prepared by mixing wheat flour with water and then kneading the resulting mixture is sufficiently rubbed under running water or in a large amount of water, starch is washed away, leaving gluten behind. Alternatively, gluten can be industrially obtained from a residue of wheat flour after starch has been removed therefrom. Gluten that is produced in the above-described manner may be used as the gluten in the present invention, or commercially available gluten may be used.

The gluten content in the low-carbohydrate wheat flour mix of the present invention is 3 to 30 mass %, preferably 5 to 20 mass %, and more preferably 7 to 15 mass %, with respect to the total mass of the mix. If the gluten content in the low-carbohydrate wheat flour mix is less than 3 mass %, a wheat flour food product having a mealy, and dry and crumbly texture may be produced. On the other hand, if the gluten content is greater than 30 mass %, a wheat flour food product having a tough texture may be produced.

The underground starch used in the present invention refers to starch derived from underground parts (stems, roots, stem tubers, and tuberous roots that exist under the soil surface) of plants, and examples thereof include potato starch, sweet potato starch, and tapioca starch. The underground starch may be used in an unmodified (raw starch) state, or alternatively, the underground starch may be modified starch obtained by at least one of esterification, etherification, oxidation, cross-linking, pregelatinization, and other treatment, or may be a mixture of raw starch and modified starch. Also, a plurality of kinds of underground starch may also be used in combination. Among these kinds of underground starch, tapioca starch, which is derived from an underground part (tuberous root) of cassava, is preferable, and acetylated tapioca starch (tapioca acetate starch) is most preferable.

The underground starch content in the low-carbohydrate wheat flour mix of the present invention is 1 to 20 mass %, preferably 3 to 15 mass %, and more preferably 5 to 12 mass %, with respect to the total mass of the mix. If the underground starch content in the low-carbohydrate wheat flour mix is less than 1 mass %, a wheat flour food product with poor meltability in the mouth and a drier and more crumbly texture may be produced, and, in the case of a deep-fried food product, the coating may not have sufficient fluffy appearances or floury feeling. On the other hand, if the underground starch content is greater than 20 mass %, a wheat flour food product with a soggy texture may be produced.

The low-carbohydrate wheat flour mix of the present invention contains 60 mass % or less of wheat flour, and, in view of the balance between the low-carbohydrate and low-calorie properties and a favorable texture of a wheat flour food product (in particular, bakery food product) to be produced, the content of wheat flour in the mix is preferably 25 to 50 mass %, and more preferably 30 to 44 mass %. Any of hard flour, semi-hard flour, plain flour, and soft flour can be used as the wheat flour. When hard flour or semi-hard flour is mainly used, a wheat flour food product to be produced tends to be substantial; when plain flour is mainly used, a wheat flour food product to be produced tends to have a viscoelastic texture; and when soft flour is mainly used, a wheat flour food product to be produced tends to have improved meltability in the mouth. Accordingly, the type and amount of wheat flour used in the low-carbohydrate wheat flour mix of the present invention can be determined according to the desired characteristics of the wheat flour food product to be produced. Particularly, in the case where the low-carbohydrate wheat flour mix of the present invention is used in the production of a bakery food product, a deep-fried food product, or a sauce, it is preferable that hard flour and soft flour be contained in the low-carbohydrate wheat flour mix in a mass ratio of 1:2 to 2:1.

The wheat flour may be used in a native state, or may be used after being heat-treated. However, heat treatment may cause proteins contained in the wheat flour to be denatured, and also may cause starch contained in the wheat flour to deteriorate. For this reason, preferably, heat-treated wheat flour is used in an amount of 50 mass % or less with respect to the total amount of wheat flour used in the low-carbohydrate wheat flour mix of the present invention.

In addition to the above-described essential components (dietary fiber material, gluten, underground starch, and wheat flour), the low-carbohydrate wheat flour mix of the present invention may further contain an emulsifier. When the low-carbohydrate wheat flour mix contains an emulsifier, a wheat flour food product to be produced has highly improved meltability in the mouth and an even further reduced dry and crumbly texture. The emulsifier used in the present invention is not limited as long as it can be used for food, and examples thereof include sucrose fatty acid ester, polyglycerol fatty acid ester, and glycerol fatty acid ester. Among these, sucrose fatty acid ester is preferable. The emulsifier content in the low-carbohydrate wheat flour mix of the present invention is preferably 0.1 to 1 mass %, and more preferably 0.2 to 0.8 mass %, with respect to the total mass of the mix.

The low-carbohydrate wheat flour mix of the present invention may appropriately contain other components that are commonly used in the production of a wheat flour food product, according to the desired quality and others of a wheat flour food product to be produced, and examples thereof include grain flours other than wheat flour, other starches (i.e., starches that do not correspond to either dietary fiber or underground starch), sugars, oils and fats, powdered milk, coloring matters, flavoring agents, salt, leavening agents, dried egg, thickeners, eggshell calcium, enzymes, taste agents, and spices. The content of the other components is preferably about 0 to 40 mass %, and more preferably about 0 to 30 mass %, with respect to the total mass of the low-carbohydrate wheat flour mix.

The low-carbohydrate wheat flour mix of the present invention is obtained by appropriately mixing the various components that have been described hereinabove. There is no particular limitation on the form of the low-carbohydrate wheat flour mix of the present invention, but the low-carbohydrate wheat flour mix of the present invention is normally in a powder form, granular form, or the like at normal temperature and pressure.

The low-carbohydrate wheat flour mix of the present invention can be used in the production of a bakery food product. The term “bakery food product” as used for the present invention refers to a food product produced by cooking (for example, baking, steaming, or deep-frying) a fermented or non-fermented dough that contains a grain flour or a starch as the main ingredient and is obtained by adding thereto, as necessary, yeast, a leavening agent (baking powder or the like), water, salt, sugar, and others as auxiliary ingredients. Examples of the bakery food product to which the present invention can be applied include: bread products; pizzas; cakes; Japanese and Western style baked sweets such as waffles, choux pastry, biscuits, thick pancakes filled with sweet bean jam, and baked buns with sweet bean jam; steamed sweets; deep-fried sweets such as doughnuts; and snack foods such as okonomiyaki (Japanese savory pancakes), takoyaki (octopus dumplings), chijimi (Korean savory pancakes), and negiyaki (Japanese green onion pancakes). Examples of the cakes include sponge cakes, butter cakes, Swiss rolls, hot cakes, bouchée, Baumkuchen, pound cakes, cheesecakes, snack cakes, muffins, bar cakes, cookies, and pancakes. The low-carbohydrate wheat flour mix of the present invention is particularly suitable for a bakery food product that is produced using a leavening agent.

The low-carbohydrate wheat flour mix of the present invention can be used in the production of a deep-fried food product. The term “deep-fried food product” as used for the present invention refers to a food product that is obtained by preparing a coating material (coating powder or batter) containing a grain flour or a starch as the main component and auxiliary components, as necessary, such as a leavening agent (baking powder etc.), water, salt, sugar, soy sauce, and garlic, attaching the coating material to the surface of ingredients to be deep-fried, and then cooking (for example, deep-frying or baking) the ingredients with the coating material. Examples of the deep-fried food product to which the present invention can be applied include tempura, karaage, tatsuta-age (Japanese deep-fried soysource-marinated chicken), and fritters.

The low-carbohydrate wheat flour mix of the present invention can be used in the production of a sauce. The term “sauce” as used for the present invention refers to a liquid food that contains wheat flour or starch and thus is viscous, or a liquid food containing as a base a roux made from wheat flour and oil/fat. Examples of the sauce to which the present invention can be applied include white sauces, dipping sauces, thick starchy sauces, and curry roux.

In addition to the above-described bakery food products, deep-fried food products, and sauces, the low-carbohydrate wheat flour mix of the present invention can be used for various wheat flour food products, including various noodles such as udon noodles (Japanese wheat noodle), suiton (Japanese flour dumplings boiled in soup), and dough for spring roll skins and jiaozi (Chinize dumpling) skins. Furthermore, the low-carbohydrate wheat flour mix of the present invention can also be used, for example, in filling such as custard cream, and as dusting flour for use in making meuniére, shogayaki (ginger pork), deep-fried foods with bread crumbs, etc. There is no limitation on the uses of the low-carbohydrate wheat flour mix of the present invention.

The low-carbohydrate wheat flour mix of the present invention can be used in the same manner as for ordinary wheat flour. Accordingly, in the production of the above-described various wheat flour food products with use of the low-carbohydrate wheat flour mix of the present invention, the low-carbohydrate wheat flour mix of the present invention can be handled in the same manner as for ordinary wheat flour. When the low-carbohydrate wheat flour mix of the present invention is used in the same manner as for ordinary wheat flour, a wheat flour food product can be produced that is equal or superior, in terms of quality, to a wheat flour food product obtained with use of ordinary wheat flour and furthermore includes a reduced amount of carbohydrates. Therefore, the low-carbohydrate wheat flour mix of the present invention is best suited to meals, nutrition therapies, and diet methods that restrict carbohydrates.

### EXAMPLES

Hereinafter, the present invention will be described in greater detail by way of examples, but the present invention is not limited thereto.

### Examples 1 to 19 and Comparative Examples 1 to 8

Low-carbohydrate wheat flour mixes were produced by appropriately mixing and stirring the components shown in Tables 1 to 4 below. The details of the components used are as follows:
Soluble dietary fiber-containing material: product name “Fuji FF” manufactured by Fuji Nihon Seito Corporation; containing inulin; a dietary fiber content 95% (indicated simply as “inulin” in the tables below)
Insoluble dietary fiber-containing material: product name “Pine Starch RT” manufactured by Matsutani Chemical Industry Co., Ltd.; containing resistant starch; a dietary fiber content 75% (indicated simply as “resistant starch” in the tables below)
Gluten: product name “domestically produced wheat protein” manufactured by Tomizawa Shouten
Underground starch: tapioca starch, acetylated tapioca starch, potato starch
Starch derived from above-ground plant part: corn starch
Emulsifier: sucrose fatty acid ester, polyglycerol fatty acid ester
Wheat flour: hard flour, soft flour

### Test Example 1

### Evaluation of Amount of Carbohydrates

The amount of carbohydrates in each of the obtained low-carbohydrate wheat flour mixes of Examples and Comparative Examples was obtained by calculation. Specifically, the carbohydrate content in each component was obtained from “Standard Tables of Food Composition in Japan—2015—(Seventh Revised Edition)”, and the amount of carbohydrates in each of the low-carbohydrate wheat flour mixes of Examples and Comparative Examples was expressed in percentage relative to the amount of carbohydrates in soft wheat flour as Reference Example, which is regarded as 100 percent. Table 1 shows the results.

### Test Example 2

### Evaluation of Bakery Food Products

Hot cakes were made from the low-carbohydrate wheat flour mixes of Examples and Comparative Examples. Specifically, 20 parts by mass of sugar and 2 parts by mass of a leavening agent were added to and sufficiently mixed with 78 parts by mass of the mix. Then, 70 parts by mass of milk and 50 parts by mass of whole egg liquid were added to 100 parts by mass of the obtained mixture, followed by stirring with a whisk, to obtain a batter. The batter was spread on a hot plate heated at 170° C., cooked for 3 minutes, then turned over, and cooked on the other, uncooked side for 1 minute and 30 seconds, and thus, a hot cake was made. The hot cakes were eaten by ten panelists, and the texture (smoothness and softness) at that time was evaluated on the following evaluation scale. Tables 1 to 4 below show the results in terms of the average of the scores given by the ten panelists.

### Evaluation Scale for Smoothness

5 points: Very good; smooth and very pleasant texture.

4 points: Good; smooth and pleasant texture.

3 points: Smoothness is felt.

2 points: Poor; dry and crumbly, and mealy.

1 point: Very poor; significantly dry and crumbly, and mealy.

### Evaluation Scale for Softness

5 points: Very good; the hot cake melts very softly in the mouth.

4 points: Good; the hot cake melts softly in the mouth.

3 points: Softness is felt.

2 points: Poor; poor meltability in the mouth, or rough or soggy texture.

1 point: Very poor; very poor meltability in the mouth, or significantly rough or soggy texture.

TABLE 1

| Mixture | | | | | | | |
|---|---|---|---|---|---|---|---|
| composition | Examples | | | Comparative Examples | | | Reference |
| (mass %) | 1 | 2 | 3 | 1 | 2 | 3 | Example |
| Inulin | 34 | | 11 | 11 | 11 | 11 | |
| Resistant | | 34 | 23 | 23 | 23 | 23 | |
| starch | | | | | | | |
| Gluten | 10 | 10 | 10 | | 10 | 10 | |
| Tapioca | 5 | 5 | 5 | 5 | | 56 | |
| starch | | | | | | | |
| Soft flour | 51 | 51 | 51 | 61 | 56 | | 100 |
| Total | 100 | 100 | 100 | 100 | 100 | 100 | 100 |
| Amount of | 59 | 68 | 65 | 75 | 64 | 78 | 100 |
| carbo- | | | | | | | |
| hydrates (vs. | | | | | | | |
| Reference | | | | | | | |
| Example; %) | | | | | | | |
| Smoothness | 4.2 | 4.3 | 4.4 | 3.0 | 3.1 | 2.3 | 4.0 |
| of hot cakes | | | | | | | |
| Softness of | 4.4 | 4.1 | 4.4 | 2.7 | 2.6 | 2.4 | 4.0 |
| hot cakes | | | | | | | |

TABLE 2

| Mixture | Comparative | | | | | | |
|---|---|---|---|---|---|---|---|
| composition | Example | Examples | | | | | |
| (mass %) | 4 | 4 | 5 | 1 | 6 | 7 | 8 |
| Inulin | 20 | 25 | 30 | 34 | 50 | 60 | 70 |
| Gluten | 10 | 10 | 10 | 10 | 10 | 10 | 10 |
| Tapioca | 5 | 5 | 5 | 5 | 5 | 5 | 5 |
| starch | | | | | | | |
| Soft flour | 65 | 60 | 55 | 51 | 35 | 25 | 15 |
| Total | 100 | 100 | 100 | 100 | 100 | 100 | 100 |
| Amount of | 73 | 68 | 63 | 59 | 44 | 35 | 26 |
| carbo- | | | | | | | |
| hydrates (vs. | | | | | | | |
| Reference | | | | | | | |
| Example; %) | | | | | | | |
| Smoothness | 3.6 | 4.0 | 4.2 | 4.2 | 4.0 | 3.9 | 3.8 |
| of hot cakes | | | | | | | |
| Softness of | 3.2 | 3.9 | 4.2 | 4.4 | 4.3 | 4.1 | 4.0 |
| hot cakes | | | | | | | |

TABLE 3

| Mixture | Com- | | | | | | | Com- |
|---|---|---|---|---|---|---|---|---|
| com- | parative | | | | | | | parative |
| position | Example | Examples | | | | | | Example |
| (mass %) | 5 | 9 | 10 | 11 | 12 | 13 | 14 | 6 |
| Inulin | 11 | 11 | 11 | 11 | 11 | 11 | 11 | 11 |
| Resistant | 23 | 23 | 23 | 23 | 23 | 23 | 23 | 23 |
| starch | | | | | | | | |
| Gluten | 1 | 3 | 5 | 7 | 15 | 20 | 30 | 35 |
| Tapioca | 5 | 5 | 5 | 5 | 5 | 5 | 5 | 5 |
| starch | | | | | | | | |
| Soft flour | 60 | 58 | 56 | 54 | 46 | 41 | 31 | 26 |
| Total | 100 | 100 | 100 | 100 | 100 | 100 | 100 | 100 |
| Amount | 74 | 72 | 70 | 68 | 60 | 55 | 45 | 40 |
| of carbo- | | | | | | | | |
| hydrates | | | | | | | | |
| (vs. | | | | | | | | |
| Reference | | | | | | | | |
| Example; | | | | | | | | |
| %) | | | | | | | | |
| Smooth- | 3.7 | 4.0 | 4.2 | 4.3 | 4.3 | 4.1 | 4.0 | 3.6 |
| ness of | | | | | | | | |
| hot cakes | | | | | | | | |
| Softness | 2.9 | 3.7 | 4.1 | 4.4 | 4.3 | 4.1 | 3.8 | 3.1 |
| of hot | | | | | | | | |
| cakes | | | | | | | | |

TABLE 4

| Mixture | Com- | | | | | | | Com- |
|---|---|---|---|---|---|---|---|---|
| com- | parative | | | | | | | parative |
| position | Example | Examples | | | | | | Example |
| (mass %) | 7 | 15 | 16 | 3 | 17 | 18 | 19 | 8 |
| Inulin | 11 | 11 | 11 | 11 | 11 | 11 | 11 | 11 |
| Resistant | 23 | 23 | 23 | 23 | 23 | 23 | 23 | 23 |
| starch | | | | | | | | |
| Gluten | 10 | 10 | 10 | 10 | 10 | 10 | 10 | 10 |
| Tapioca | 0.5 | 1 | 3 | 5 | 12 | 15 | 20 | 25 |
| starch | | | | | | | | |
| Soft flour | 55.5 | 55 | 53 | 51 | 44 | 41 | 36 | 31 |
| Total | 100 | 100 | 100 | 100 | 100 | 100 | 100 | 100 |
| Amount | 64 | 64 | 65 | 65 | 67 | 68 | 69 | 70 |
| of carbo- | | | | | | | | |
| hydrates | | | | | | | | |
| (vs. | | | | | | | | |
| Reference | | | | | | | | |
| Example; | | | | | | | | |
| %) | | | | | | | | |
| Smooth- | 3.0 | 3.9 | 4.2 | 4.4 | 4.4 | 4.2 | 4.1 | 3.6 |
| ness of | | | | | | | | |
| hot cakes | | | | | | | | |
| Softness | 3.7 | 4.2 | 4.3 | 4.4 | 4.2 | 4.0 | 3.8 | 3.1 |
| of hot | | | | | | | | |
| cakes | | | | | | | | |

### Examples 20 and 21 and Comparative Examples 9 and 10

Low-carbohydrate wheat flour mixes were produced using various types of underground starch according to the mixture compositions shown in Table 5. The amount of carbohydrates in each of these mixes was obtained in the same manner as in Test Example 1. Also, hot cakes were made from these mixes and then evaluated in the same manner as in Test Example 2. Table 5 shows the results.

TABLE 5

| Mixture | | | | | |
|---|---|---|---|---|---|
| composition | Examples | | | Comparative Examples | |
| (mass %) | 3 | 20 | 21 | 9 | 10 |
| Inulin | 11 | 11 | 11 | 11 | 11 |
| Resistant | 23 | 23 | 23 | 23 | 23 |
| starch | | | | | |
| Gluten | 10 | 10 | 10 | 10 | 10 |
| Tapioca | 5 | — | — | — | — |
| starch | | | | | |
| Acetylated | — | 5 | — | — | — |
| tapioca starch | | | | | |
| Potato starch | — | — | 5 | — | — |
| Corn starch | — | — | — | 5 | |
| Wheat starch | — | — | — | — | 5 |
| Soft flour | 51 | 51 | 51 | 51 | 51 |
| Total | 100 | 100 | 100 | 100 | 100 |
| Amount of | 65 | 65 | 65 | 65 | 65 |
| carbohydrates | | | | | |
| (vs. | | | | | |
| Reference | | | | | |
| Example; %) | | | | | |
| Smoothness | 4.4 | 4.6 | 4.1 | 3.2 | 3.4 |
| of hot cakes | | | | | |
| Softness of | 4.4 | 4.6 | 4.0 | 2.9 | 3.0 |
| hot cakes | | | | | |

### Examples 22 to 27

Low-carbohydrate wheat flour mixes containing an emulsifier were produced according to the mixture compositions shown in Table 6. The amount of carbohydrates in each of these mixes was obtained in the same manner as in Test Example 1. Also, hot cakes were made from these mixes and then evaluated in the same manner as in Test Example 2. Table 6 shows the results.

TABLE 6

| Mixture | | | | | | | |
|---|---|---|---|---|---|---|---|
| composition | Examples | | | | | | |
| (mass %) | 3 | 22 | 23 | 24 | 25 | 26 | 27 |
| Inulin | 11 | 11 | 11 | 11 | 11 | 11 | 11 |
| Resistant starch | 23 | 23 | 23 | 23 | 23 | 23 | 23 |
| Gluten | 10 | 10 | 10 | 10 | 10 | 10 | 10 |
| Tapioca starch | 5 | 5 | 5 | 5 | 5 | 5 | 5 |
| Sucrose fatty | — | 0.1 | 0.2 | 0.5 | — | 0.8 | 1 |
| acid ester | | | | | | | |
| Polyglycerol | — | — | — | — | 0.5 | — | — |
| fatty acid ester | | | | | | | |
| Soft flour | 51 | 50.9 | 50.8 | 50.5 | 50.5 | 50.2 | 50 |
| Total | 100 | 100 | 100 | 100 | 100 | 100 | 100 |
| Amount of | 65 | 65 | 65 | 65 | 65 | 64 | 64 |
| carbohydrates | | | | | | | |
| (vs. Reference | | | | | | | |
| Example; %) | | | | | | | |
| Smoothness of | 4.4 | 4.5 | 4.6 | 4.7 | 4.5 | 4.6 | 4.5 |
| hot cakes | | | | | | | |
| Softness of hot | 4.4 | 4.5 | 4.6 | 4.7 | 4.5 | 4.5 | 4.2 |
| cakes | | | | | | | |

### Examples 28 to 34

Low-carbohydrate wheat flour mixes were produced while making a change in wheat flour according to the mixture compositions shown in Table 7. The amount of carbohydrates in each of these mixes was obtained in the same manner as in Test Example 1. Also, hot cakes were produced from these mixes and then evaluated in the same manner as in Test Example 2. Table 7 shows the results.

TABLE 7

| Mixture | | | | | | | |
|---|---|---|---|---|---|---|---|
| composition | Examples | | | | | | |
| (mass %) | 28 | 29 | 30 | 31 | 32 | 33 | 34 |
| Inulin | 20 | 20 | 20 | 20 | 20 | 20 | 20 |
| Resistant | 20 | 20 | 20 | 20 | 20 | 20 | 20 |
| starch | | | | | | | |
| Gluten | 10 | 10 | 10 | 10 | 10 | 10 | 10 |
| Tapioca | 5 | 5 | 5 | 5 | 5 | 5 | 5 |
| starch | | | | | | | |
| Hard flour | 45 | 33.7 | 30 | 22.5 | 15 | 11.3 | — |
| Soft flour | — | 11.3 | 15 | 22.5 | 30 | 33.7 | 45 |
| Hard flour: | 1:0 | 3:1 | 2:1 | 1:1 | 1:2 | 1:3 | 0:1 |
| soft flour | | | | | | | |
| (mass ratio) | | | | | | | |
| Total | 100 | 100 | 100 | 100 | 100 | 100 | 100 |
| Amount of | 57 | 57 | 58 | 58 | 58 | 58 | 59 |
| carbohydrates | | | | | | | |
| (vs. | | | | | | | |
| Reference | | | | | | | |
| Example; %) | | | | | | | |
| Smoothness | 4.2 | 4.2 | 4.3 | 4.4 | 4.4 | 4.2 | 4.0 |
| of hot cakes | | | | | | | |
| Softness of | 3.9 | 4.0 | 4.3 | 4.4 | 4.4 | 4.3 | 4.1 |
| hot cakes | | | | | | | |

### Test Example 3

### Evaluation of Deep-Fried Food Products

Chicken karaage (Japanese deep-fried chicken) was made with the low-carbohydrate wheat flour mixes of Examples 1 to 3 and Comparative Examples 1 to 3. Specifically, chicken thigh was cut into pieces of 20 g each and preliminarily seasoned to prepare the ingredients to be deep-fried. The ingredients were coated with the low-carbohydrate wheat flour mix such that the amount of the mix attached to the ingredients was 15 g per 100 g of chicken, and then deep-fried in salad oil heated at 170° C. for 3 minutes to thereby obtain karaage. The appearance and texture of the karaage were evaluated by ten expert panelists on the following evaluation scale. Table 8 shows the results in terms of the average of the scores given by the ten panelists.

### Evaluation Scale for Appearance

5 points: Very good; satisfactory mountain/valley roughness is observed over the entire surface.

4 points: Good; mountain/valley roughness is observed over the entire surface.

3 points: mountain/valley roughness is observed on about 50 to 80% of the surface.

2 points: Poor; mountain/valley roughness of the surface is somewhat unsatisfactory.

1 point: Very poor; the surface has little mountain/valley roughness.

### Evaluation Scale for Texture

5 points: Very good; the coating is satisfactorily crispy and also readily meltable.

4 points: Good; the coating is crispy and also readily meltable.

3 points: The coating is crispy but somewhat dry and crumbly.

2 points: Poor; the crispness of the coating is somewhat unsatisfactory, and the coating is dry and crumbly.

1 point: Very poor; the coating lacks in crispness and is dry and crumbly.

TABLE 8

| Mixture | | | | | | | |
|---|---|---|---|---|---|---|---|
| composition | Examples | | | Comparative Examples | | | Reference |
| (mass %) | 1 | 2 | 3 | 1 | 2 | 3 | Example |
| Inulin | 34 | — | 11 | 11 | 11 | 11 | — |
| Resistant | — | 34 | 23 | 23 | 23 | 23 | — |
| starch | | | | | | | |
| Gluten | 10 | 10 | 10 | — | 10 | 10 | — |
| Tapioca | 5 | 5 | 5 | 5 | — | 56 | — |
| starch | | | | | | | |
| Soft flour | 51 | 51 | 51 | 61 | 56 | — | 100 |
| Total | 100 | 100 | 100 | 100 | 100 | 100 | 100 |
| Appearance | 4.3 | 4.4 | 4.5 | 3.8 | 3.5 | 3.7 | 3.5 |
| of karaage | | | | | | | |
| Texture of | 4.1 | 4.4 | 4.5 | 2.9 | 3.2 | 2.3 | 3.5 |
| karaage | | | | | | | |

### Test Example 4

### Evaluation of Sauces

White sauces were made with the low-carbohydrate wheat flour mixes of Examples 1 to 3 and Comparative Examples 1 to 3. Specifically, 100 g of the low-carbohydrate wheat flour mix and 130 g of butter were put in a pot and stirred with a wooden spatula over a low heat. When the mix and the butter were substantially uniformly mixed, 1.3 L of milk was added thereto, and the resulting mixture was cooked together over a medium heat until boiling. The mixture was seasoned with a little salt and pepper, and then cooked over a low heat for 5 minutes to thereby obtain a white sauce. The texture of the sauces was evaluated by ten expert panelists on the following evaluation scale. Table 9 shows the results in terms of the average of the scores given by the ten panelists.

### Evaluation Scale for Texture

5 points: Very good; entirely smooth texture.

4 points: Good; smooth texture.

3 points: Slightly rough texture.

2 points: Poor; Somewhat rough texture.

1 point: Very poor; Significantly rough texture.

TABLE 9

| Mixture | | | | | | | |
|---|---|---|---|---|---|---|---|
| composition | Examples | | | Comparative Examples | | | Reference |
| (mass %) | 1 | 2 | 3 | 1 | 2 | 3 | Example |
| Inulin | 34 | | 11 | 11 | 11 | 11 | |
| Resistant | | 34 | 23 | 23 | 23 | 23 | |
| starch | | | | | | | |
| Gluten | 10 | 10 | 10 | | 10 | 10 | |
| Tapioca | 5 | 5 | 5 | 5 | | 56 | |
| starch | | | | | | | |
| Soft flour | 51 | 51 | 51 | 61 | 56 | | 100 |
| Total | 100 | 100 | 100 | 100 | 100 | 100 | 100 |
| Texture of | 4.3 | 4.1 | 4.5 | 3.8 | 3.6 | 2.8 | 4.0 |
| sauce | | | | | | | |

### INDUSTRIAL APPLICABILITY

According to the present invention, it is possible to provide a low-carbohydrate wheat flour mix that contains dietary fiber, which leads low-carbohydrate and low-calorie, and can be used in the production of bakery food products, deep-fried food products, and sauces in the same manner as for ordinary wheat flour.

1. A low-carbohydrate wheat flour mix comprising 25 mass % or greater of a dietary fiber material, 3 to 30 mass % of gluten, 1 to 20 mass % of starch derived from an underground plant part, and 60 mass % or less of wheat flour, all with respect to a total mass of the mix.

2. The low-carbohydrate wheat flour mix as set forth in claim 1, further comprising 0.1 to 1 mass % of an emulsifier.

3. The low-carbohydrate wheat flour mix as set forth in claim 1, wherein the dietary fiber material contains soluble dietary fiber and insoluble dietary fiber.

4. The low-carbohydrate wheat flour mix as set forth in claim 1, wherein the starch derived from an underground plant part is tapioca starch.

5. The low-carbohydrate wheat flour mix as set forth in claim 1, wherein the wheat flour contains hard flour and soft flour in a mass ratio of 1:2 to 2:1.

6. A method for producing a bakery food product, a deep-fried food product, or a sauce, the method including using the low-carbohydrate wheat flour mix as set forth in claim 1.
